(19) United States
(12) Patent Application Publication
(10) Pub. No.: US 2013/0145790 A1
(43) Pub. Date: Jun. 13, 2013

(54) HEATING AND COOLING DEVICE AND HEATING AND COOLING MODULE FOR A HEATING AND COOLING DEVICE

(71) Applicants: Tilo Schäfer, Daubach (DE); Stefan Schüssler, Frankfurt (DE); Willi Parsch, Seeheim (DE)

(72) Inventors: Tilo Schäfer, Daubach (DE); Stefan Schüssler, Frankfurt (DE); Willi Parsch, Seeheim (DE)

(21) Appl. No.: 13/818,563

(22) PCT Filed: Aug. 16, 2011
(86) PCT No.: PCT/DE2011/001618

§ 371 Date: Feb. 22, 2013

(30) Foreign Application Priority Data
Aug. 24, 2010 (DE) 10 2010 035 272.1

(51) Int. Cl. B60H 1/32

(52) U.S. Cl. CPC B60H 1/323; B60H 1/3213; B60H 1/3227
USPC 62/333; 62/506; 62/513

(57) ABSTRACT

A heating/cooling device (1) is proposed for vehicles, in particular motor vehicles, with a compressor (3), a refrigerant circuit (5), a gas cooler (7), an evaporator (9), and with an expansion valve (37) arranged between the gas cooler (7) and evaporator (9) in the refrigerant circuit (5). The heating/cooling device (1) is distinguished in that the gas cooler (7) or the evaporator (9) is coupled with a liquid coolant circuit (13, 23) which cooperates with an interior heat exchanger (19) or an external air heat exchanger (27), or that the gas cooler (7) and the evaporator (9) are each coupled with an its own liquid coolant circuit (13, 23), wherein one of the liquid coolant circuits (13, 23) cooperates with the interior heat exchanger (19) and the other liquid coolant circuit (23, 13) cooperates with the external air heat exchanger (27).

The invention concerns a heating/cooling device according to the preamble of Claim 1 and a heating/cooling module according to the preamble of Claim 13.

Such heating/cooling devices are well known. They have a compressor which compresses a refrigerant in a refrigerant circuit, and a gas cooler which serves to cool the compressed and hence heated refrigerant. They also have an evaporator and an expansion valve integrated in the refrigerant circuit between the gas cooler and the evaporator. The expanded refrigerant evaporates in the evaporator where coldness is available.

In conventional heating/cooling devices, the gas cooler is cooled by an air flow. The evaporator is also exposed to an air flow in order to utilize the coldness provided in the evaporator or to heat the refrigerant present in the evaporator.

It has been found that the heat exchange both in the gas cooler and the evaporator is inadequate, so that relatively large areas must be made available through which air can flow.

The object of the invention is therefore to create a device of the type mentioned here which allows a very compact construction.

To achieve this object, a heating/cooling device is proposed of the type mentioned above, which comprises the features cited in Claim 1. The heating/cooling device of the type described here is distinguished in that the gas cooler or the evaporator is coupled with a liquid coolant circuit which cooperates with an interior heat exchanger or an external air heat exchanger. The liquid coolant circuit coupled to the gas cooler or evaporator allows a very effective heat exchange, so that the heat transfer areas available can be formed very much more compactly than known ones.

The heating/cooling device is distinguished optionally in that both the gas cooler and the evaporator are coupled with their own separate liquid coolant circuit, wherein one of the liquid coolant circuits cooperates with the interior heat exchanger and the other liquid coolant circuit cooperates with the external air heat exchanger. This embodiment of the heating/cooling device also ensures that the thermal energy in the gas cooler or the evaporator is transmitted very effectively to the liquid coolant.

An embodiment example of the heating/cooling device is preferred in which the refrigerant circuit comprises an internal heat exchanger which transmits heat from the refrigerant flowing from the gas cooler to the expansion valve, to the refrigerant flowing from the evaporator to the compressor. This increases the efficiency of the refrigerant circuit.

In a further preferred embodiment example of the heating/cooling device, an accumulator is integrated in the refrigerant circuit which can compensate for differences in refrigerant demand in particular depending on operating point.

A particularly preferred embodiment example is characterized in that when the gas cooler and evaporator each comprise an own liquid coolant circuit, in a heating mode the coolant circuit of the gas cooler cooperates with the interior heat exchanger and the liquid coolant circuit of the evaporator cooperates with the external air heat exchanger. In cooling mode, the liquid coolant circuit of the gas cooler is coupled with the external air heat exchanger and the liquid coolant circuit of the evaporator is coupled with the interior heat exchanger. In this way the existing elements of the device can be utilized very efficiently so that it is very compact.

A further embodiment example of the heating/cooling device is characterized in that the liquid coolant circuit of the gas cooler cooperates with at least two changeover valves which supply the liquid coolant, depending on operating mode, to the interior heat exchanger or the external air heat exchanger, and that the liquid coolant circuit of the evaporator cooperates with at least two changeover valves which supply the liquid coolant, depending on operating mode, to the external air heat exchanger or the interior heat exchanger.

A preferred embodiment example is distinguished in that the compressor is included in the liquid coolant circuit which cooperates with the external heat exchanger so that heat generated in operation of the compressor can be dissipated and where applicable the efficiency of the device in heating mode increased.

Furthermore an embodiment example of the heating/cooling device is preferred which is distinguished in that between the liquid coolant circuit of the gas cooler and the liquid coolant circuit of the evaporator, a valve is provided via which the heat from the liquid coolant circuit of the gas cooler in heating mode can be introduced into the evaporator. This increases the efficiency of the device in this operating mode.

In a preferred embodiment example of the heating/cooling device it is proposed that the valve is formed as a non-return valve or an electric or thermostatic valve.

Finally an embodiment example of the heating/cooling device is preferred which is distinguished in that between the liquid coolant circuit of the gas cooler and the liquid coolant circuit of the evaporator, a mixer valve is provided to which warm liquid coolant from one of the two liquid coolant circuits and/or cold liquid coolant from the other liquid coolant circuit is supplied. The liquid coolant which can be extracted from the mixer valve is thus available for tempering a consumer, for example an accumulator.

The object of the invention is also to create a heating/cooling module for a heating/cooling device which is as compact as possible, has as few valves as possible and in particular as few connections as possible for connection to a periphery, in particular a vehicle periphery.

This object is achieved by the creation of a heating/cooling module with the features of claim 13. This has a first input which is in fluid connection with the coolant input of a gas cooler. It also comprises a first output. The first input is in fluid connection with the first output, whereby a first partial liquid coolant circuit is formed. It also has a second input and a second output, wherein the second output is in fluid connection with the coolant output of an evaporator. The second input is in fluid connection with the second output, whereby a second partial liquid coolant circuit is formed. The module furthermore comprises a compressor. It is distinguished by a valve device via which the compressor can be allocated optionally to the first or the second partial liquid coolant circuit. A corresponding valve device requires few valves. Because the valve device is contained in the module, the latter only has four connections to a periphery, namely the first and second input and the first and second output. The module is therefore very compact and simple in construction. The periphery in particular comprises the interior heat exchanger and the external air heat exchanger of the heating/cooling device for which the heating/cooling module is intended, so that complete liquid coolant circuits are implemented when the module is integrated in a periphery, preferably in a vehicle.

A heating/cooling module is preferred in which by means of the valve device, optionally the second input can be connected to the coolant input of the evaporator, or the coolant output of the gas cooler can be connected to the first output. This ensures that the heating/cooling module comprises the functionality necessary for operation of the heating/cooling device.

Also a heating/cooling module is preferred in which the valve device comprises two preferably motor-controlled changeover valves. Particularly preferably, by means of these valves the coolant input of the compressor can be connected to the second input or to the coolant output of the gas cooler. At the same time preferably the coolant output of the compressor can be connected to the coolant input of the evaporator or to the first output. In this way the heating/cooling module can comprise as few valves as possible.

A heating/cooling module is preferred in which the valve device comprises a valve assembly. In this way preferably the second input can be connected to the coolant input of the evaporator or the coolant output of the gas cooler can be connected to the first output. Particularly preferably switching to and fro between these connections is possible.

A heating/cooling module is preferred in which the valve assembly is formed as a motorized valve with two valve actuators which can be adjusted in opposite directions. In total thus the valve device preferably comprises three motorized valves, namely two motor-controlled changeover valves and one motorized valve with two valve actuators which can be adjusted in opposite directions. It has been shown that the heating/cooling module then comprises particularly few valves.

Finally a heating/cooling module is also preferred in which the valve assembly comprises two temperature-controlled valves. In total thus the valve device preferably comprises two motor-controlled changeover valves and two temperature-controlled valves. In this case therefore only a low number of valves is provided in the heating/cooling module. The heating/cooling module is very compact and also has only a low number of connections. Further valves which may be necessary for operation of the heating/cooling device are located in the periphery. It is thus possible to offer a very compact heating/cooling module which can be expanded with additional functionality on the side of the periphery.

Further advantageous embodiments arise from the subclaims.

The invention is explained in more detail below with reference to the drawing. Here:

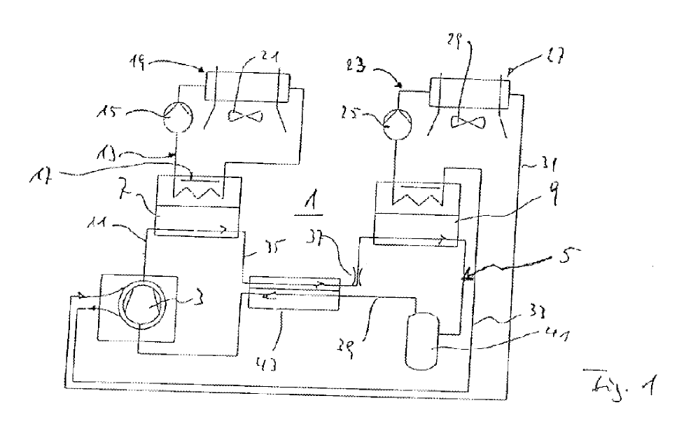

FIG. 1 shows a principle sketch of a heating/cooling device in heating mode;

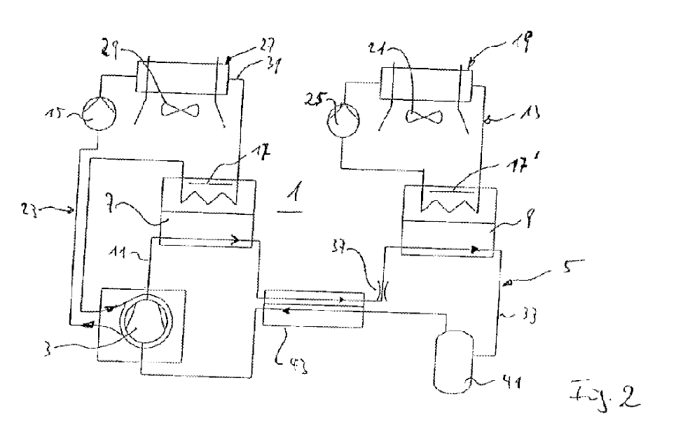

FIG. 2 a principle sketch of a heating/cooling device in cooling mode;

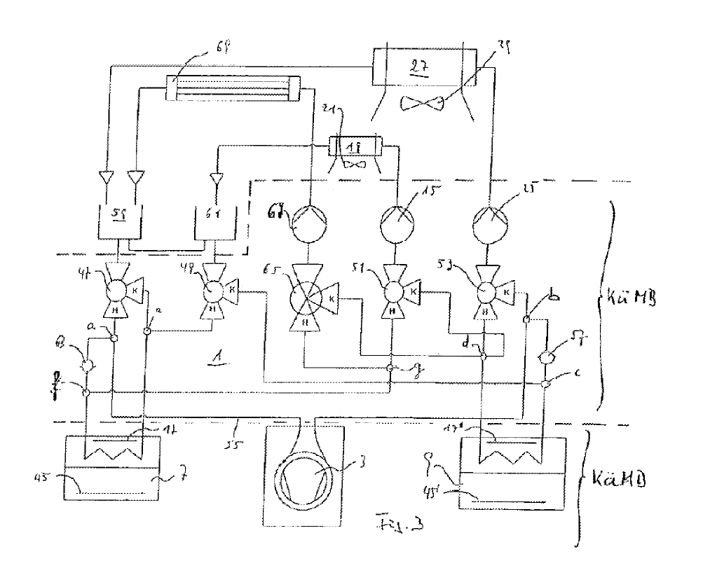

FIG. 3 a principle sketch of a heating/cooling device with a depiction of the switching of the individual elements of the heating/cooling device;

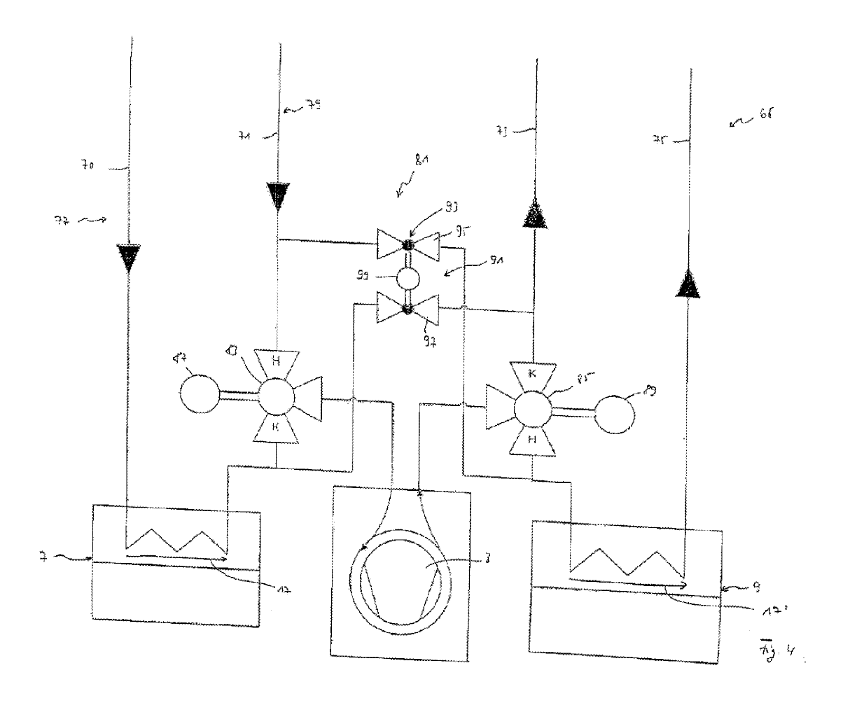

FIG. 4 a principle sketch of an embodiment example of a heating/cooling module, and

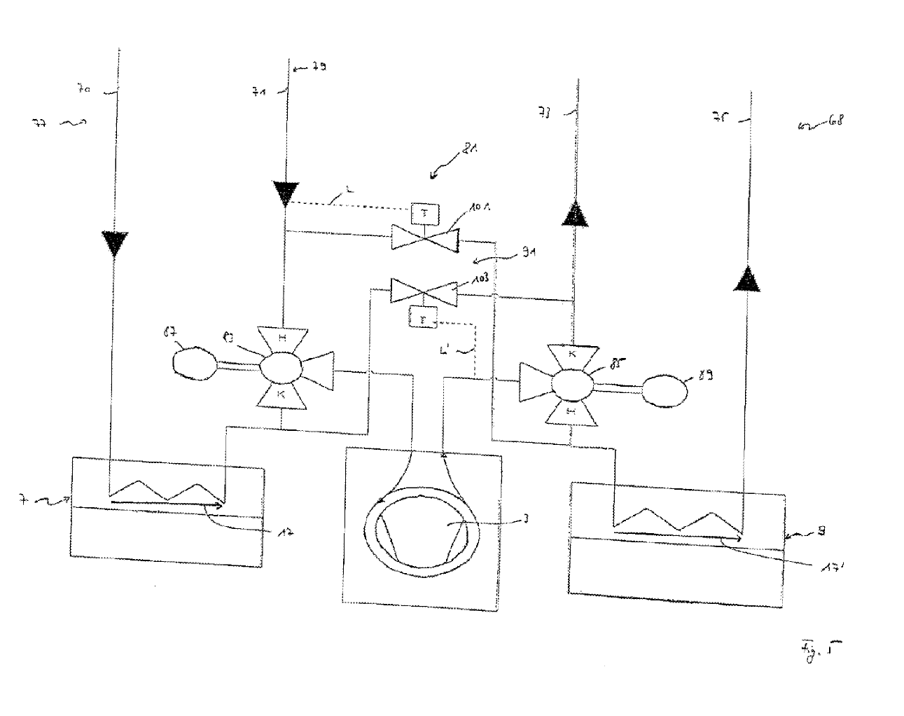

FIG. 5 a principle sketch of a second embodiment example of a heating/cooling module.

FIG. 1 shows a heating/cooling device 1 with a compressor 3, a refrigerant circuit 5, a gas cooler 7 and an evaporator 9. In the refrigerant circuit, a refrigerant is compressed in the compressor 3 and supplied via a line 11 to the gas cooler 7. Here the heat generated by compression can be dissipated. For this the gas cooler is coupled with a first liquid coolant circuit 13 to which the heat from the refrigerant is dissipated. The first liquid coolant circuit comprises a pump 15 which allows the liquid coolant to circulate according to arrow 17. Downstream of the pump 15 is arranged an interior heat exchanger 19 through which the liquid coolant flows. The heat from the liquid coolant is introduced via the interior heat exchanger into the interior, wherein preferably a fan 21 is provided which ensures an air flow through the heat exchanger.

The medium emerging from the interior heat exchanger 19 returns to the gas cooler in the liquid coolant circuit 13 and is thus available for dissipating the heat resulting from the compressed refrigerant.

It is clear from FIG. 1 that a second liquid coolant circuit 23 is allocated to the evaporator 9 and comprises a pump 25, an exterior heat exchanger 27 which is arranged downstream thereof and through which flows an air flow, preferably produced by a fan 29. The liquid coolant present in the second liquid coolant circuit 23 passes via a line 31 from the external air heat exchanger to the compressor 3. The liquid coolant serves to dissipate the operating heat from the compressor and supply this via a line 33 to the evaporator 9. In heating mode the waste heat from the compressor 3 is coupled into the refrigerant circuit, so the compressor 3 acts as a useful heat source.

The refrigerant flowing out from the gas cooler 7 passes via a line 35 to an expansion valve 37. The medium compressed by the compressor expands in the line region after the expansion valve 37 and, greatly cooled, enters the evaporator 9. The cold expanded refrigerant is heated by energy obtained via the external heat exchanger 27 and the waste heat emitted in operation by the compressor, before it is supplied again to the compressor.

Preferably an accumulator 41 is provided in the line 39 leading from the evaporator 9 to the compressor 3, and serves as a compensation reservoir for the refrigerant in the refrigerant circuit 5.

To cool the refrigerant flowing from the gas cooler 7 to the evaporator 9, an internal heat exchanger 43 can be provided through which flows firstly the medium flowing to the evaporator and secondly the medium flowing to the compressor. Here too a heat transfer is provided to increase the efficiency of the refrigerant circuit.

FIG. 1 therefore shows the following:

A conventional refrigerant circuit 5 is provided with a compressor 3, a gas cooler 7 and an evaporator 9. To be able to dissipate the heat in the gas cooler 7 particularly efficiently, a liquid coolant flows through the gas cooler. The same applies to the evaporator. Here too a particularly effective heat exchange is achieved because liquid coolant flows through the evaporator 9 and can absorb energy from the external air heat exchanger 27 and waste heat from the compressor 3.

Because the gas cooler 7 and the evaporator 9 cooperate with a liquid coolant i.e. there is a very efficient heat exchange, relatively small heat exchange surface areas are required so these components can be formed very compactly.

This means that the heating/cooling device 1 can be formed relatively small and that the individual components are comparatively economical.

FIG. 2 shows the heating/cooling device in another operating state, namely in cooling mode.

The same parts and those with equivalent function carry the same reference numerals, so to this extent reference is made to the description of FIG. 1.

It is evident from FIG. 2 that the refrigerant circuit 5 is identical in construction to that in FIG. 1. It thus comprises a compressor 3, a gas cooler 7, an evaporator 9, an accumulator 41 and preferably an internal heat exchanger 43. The refrigerant is compressed by the compressor 3 and conveyed via a line 11 to the gas cooler 7 where the heat generated by compression can be extracted. The compressed refrigerant passes through an internal heat exchanger 43 via the expansion valve 37 to the evaporator 9, where it has a significantly lower temperature than in the gas cooler 7. The cooled refrigerant passes from the evaporator 9 via the line 33, accumulator 41 and internal heat exchanger 43 to the compressor 3, whereby the refrigerant circuit 5 is closed.

A liquid coolant flows through the gas cooler 7 in the direction of arrow 17 and absorbs the waste heat from the compressor 3 and, conveyed by the pump 15, here reaches the external air heat exchanger 27. Via the external air heat exchanger 27, the operating or waste heat from the compressor is dissipated so that it does not enter the refrigerant circuit 5. Extracting this heat guarantees that the cooling process does not deteriorate. Via the second liquid coolant circuit 23, energy transferred from the gas cooler 7 to the liquid coolant is also supplied to the external air heat exchanger 27. This energy, like the waste heat from the compressor 3, is emitted to the environment. Preferably for this a fan 29 is used which in a targeted fashion conveys the air flow through the external heat exchanger 27. FIG. 2 clearly shows that in cooling mode of the heating and cooling device 1, the second liquid coolant circuit 23 is coupled to the gas cooler 7 and no longer to the evaporator 9. The second liquid coolant circuit 23 is therefore here allocated differently than in the heating mode according to FIG. 1. Correspondingly, in cooling mode the first liquid coolant circuit 13 is coupled with the evaporator 9 so that the medium present in the first liquid coolant circuit 13 is conveyed in the direction of the arrow 17 through the evaporator 9, wherein here the pump 25 achieves the coolant transport.

In cooling operation too, the cold refrigerant flowing through the evaporator 9 is heated. Here via the first liquid coolant circuit 13, energy is transmitted by means of the interior heat exchanger 19. Preferably the interior heat exchanger 19 carries an air flow which can preferably be intensified by a fan 21.

It is decisive that the heating/cooling device according to FIG. 2 is particularly advantageous in cooling mode and heating mode, because a liquid coolant flows through the gas cooler 7 and evaporator 9 so that a particularly good heat transport is guaranteed since, on heat transmission from the liquid coolant to the liquid refrigerant, a great deal of heat can be transmitted within a small construction space.

Comparison of FIGS. 1 and 2 shows that the basic structure of the heating/cooling device according to FIGS. 1 and 2 remains the same and that the number of components is unchanged. There is merely an exchange of the coupling of the liquid coolant circuits in heating and cooling operation.

The implementation of the switching of the liquid coolant circuits is shown in FIG. 3. Here too the same components and those with equivalent function carry the same reference numerals, so reference is made to this extent to the description of FIGS. 1 and 2.

FIG. 3 shows the compressor 3, gas cooler 7 and evaporator 9. Here too the first liquid coolant circuit 13 and the second liquid coolant circuit 23 can be seen. For reasons of better clarity, in FIG. 3 the refrigerant circuit 5—as shown in FIGS. 1 and 2—is not depicted. It is however constructed identically to that described above. An arrow 45 in the gas cooler 7 and an arrow 45′ in the evaporator 9 indicate that refrigerant flows through these components, preferably in the opposite direction to the liquid coolant.

FIG. 3 also shows the interior heat exchanger 19 and external air heat exchanger 27 which are exposed to an air flow which is preferably caused, in particular in the case of the interior heat exchanger 19, by a fan 21, or 29 for the external air heat exchanger 27. Where applicable the fan 29 in connection with the external air heat exchanger 27 can be omitted if an air flow is generated in a different manner.

FIG. 3 also shows the pump 15 allocated to the interior heat exchanger 19 and the pump 25 allocated to the external air heat exchanger 27, which serve to ensure the circulation of liquid coolant through the two heat exchangers 19 and 27.

FIGS. 1 and 2 depict in general that the first liquid coolant circuit 13 and the second liquid coolant circuit 23, depending on operating state, can be allocated either to the gas cooler 7 or to the evaporator 9. Here in FIG. 3, with the use of changeover valves, it is explained how such a switch is preferably achieved.

FIG. 3 shows preferably four changeover valves 47, 49, 51, and 53 which are each fitted with three connections. A first connection is marked H, a second K. A third is unmarked. The letters indicate that in heating mode, a passage exists between connection H and the unmarked connection. Connection K is blocked. Similarly in cooling mode of the heating/cooling device 1, a passage exists in the changeover valves 47, 49, 51 and 53 between connection K and the unmarked connection, while the connection marked H is blocked.

In the heating mode shown in FIG. 1 of the heating/cooling device 1, according to FIG. 3 therefore the connection K of all changeover valves is blocked. Via connection H, the first changeover valve 47 is connected with the compressor 3 via node point a and a line 55 such that its operating heat is dissipated and supplied to the evaporator 9 via a node b, a non-return valve 57 and a node c. This is connected with the external air heat exchanger 27 via a line leading to a node d and via connection H of the changeover valve 53 and via the pump 25.

From the external air heat exchanger 27, the liquid coolant enters a tank 59 and from this flows back to connection H of the changeover valve 47 via its unmarked connection.

In heating mode therefore the second liquid coolant circuit is implemented as shown in FIG. 1: A liquid coolant therefore flows in this circuit around the compressor 3 to extract waste heat here, through the evaporator 9 and from there through connection H of changeover valve 53 to the external air heat exchanger 27, and from there back to the changeover valve 47.

Thus in heating mode the first liquid coolant circuit 13 shown in FIG. 1 is implemented. In heating mode therefore the liquid coolant passes from connection H of the changeover valve 49 to a node point e. It cannot flow through the changeover valve 47 because there connection K is blocked. The liquid coolant rather reaches the gas cooler 7 and flows through this in the direction of arrow 17. Thus it reaches a node f and from there passes to a node g and from there to the connection H of the changeover valve 51. Via its unmarked connection, it passes to pump 15 and from there to the interior heat exchanger 19 and on to a tank 61, from which it then passes through the changeover valve 49 via its unmarked connection to its connection H. Thus here too a closed circuit exists which corresponds to the first liquid coolant circuit 13 in FIG. 1.

A description is now given below of the cooling mode explained with reference to FIG. 2, in which according to FIG. 3 all connections H of changeover valves 47, 49, 51, are blocked and all connections K are open and form a connection to the unmarked connections of the respective valves.

In cooling mode therefore the liquid coolant passes via connection K of changeover valve 47 to node point e and from there, according to arrow 17, through the gas cooler 7 to the node point f. Via the node point f the medium cannot flow further through the changeover valve 51 because via node g it meets the closed connection H of this valve. Rather the liquid coolant passes via node point f and via a valve 63, here formed as a non-return valve, to the node a. In the flow direction of the liquid coolant from the node f to node a therefore, the non-return valve 63 opens. However it prevents a flow in the reverse direction from node a to node f.

The liquid coolant present at node a cannot flow further via the blocked connection H of the changeover valve 47. It therefore flows via the line 55 to the compressor 3 in order there to absorb its operating heat, and passes on to the node point b. A flow to the evaporator 9 is prevented by the non-return valve 57 because of the higher pressure in the node point c. The liquid coolant therefore passes from node b via the connection K of the changeover valve 53 to its unmarked connection, via the pump 25 and the external air heat exchanger 27, to tank 59. This is connected to the unmarked connection of changeover valve 47 so that the liquid coolant can pass from the tank 59 to connection K of changeover valve 47, and the liquid coolant circuit shown in cooling mode is closed. Thus the second liquid coolant circuit 23 shown in FIG. 2 is achieved.

In cooling mode, the liquid coolant passes from connection K of changeover valve 49 to node c and because the non-return valve 57 is closed, from there according to arrow 17′ through the evaporator 9 to node d. It flows on from there to connection K of the changeover valve 51 and, via its unmarked connection and pump 15, to the interior heat exchanger 19. It flows on from there to tank 61 and thus reaches the unmarked connection of changeover valve 49. Thus the first liquid coolant circuit 13 according to FIG. 2 for cooling mode is achieved.

The non-return valve 63 is preferably formed so that in heating mode a targeted leakage is implemented. This means that liquid coolant reaching node point f can pass in targeted leakage via the non-return valve 63 to the node point a and from there via the compressor 3 to node point b. In this case, i.e. with the deliberate leakage, the liquid medium passes via the non-return valve 57 to node point c and from there to the evaporator 9 so that additional energy from the gas cooler 7, i.e. not only the waste heat from the compressor 3, can be fed into the evaporator 9. This is useful in particular in an initial heating phase in winter heating mode. In this way a connection is deliberately created between the first liquid coolant circuit 13 and the second liquid coolant circuit 23.

The non-return valve 63 can also be formed as an electric or thermostatic valve if such a control is deliberately desired.

It is evident from the explanations of FIG. 3 and the depiction of the function of the changeover valves 47, 49, 51 and 53 that, by corresponding switching of these valves, the flow of the liquid coolant is controlled such that in heating mode, the external air heat exchanger 27 is coupled with the evaporator 9 and the interior heat exchanger 19 with the gas cooler 7. This is also evident from FIG. 1.

In cooling mode according to FIG. 2, by means of the changeover valves 47, 49, 51 and 53, the liquid coolant flow is controlled such that the interior heat exchanger 13 is coupled with the evaporator 9 and the external air heat exchanger 27 with the gas cooler 7.

The heating/cooling device 1 explained here is preferably provided with a mixer valve 65 which has a connection H, a connection K and an unmarked connection. Using this mixer valve 65, the quantity of liquid coolant passing from connection H and connection K to the unmarked connection can be set in a targeted fashion. The medium is conveyed by a pump 67 to a consumer and on to the tank 59. The consumer can thus be exposed to tempered liquid coolant and can be cooled or heated depending on the setting of the mixer valve. For example an accumulator 69 can be exposed to liquid coolant, the temperature of which can be set to a desired value using the mixer valve 65. The accumulator 69 can therefore be heated or cooled.

The mixer valve 65 is connected via its connection H with node point g, the warmest point of the liquid coolant system. Similarly connection K of the mixer valve 65 is connected to node point d, the coldest point of the liquid coolant system.

The mixer valve 65 is preferably formed as an electrically regulated or thermostatic valve, wherein in principle domestic mixer valves can be used.

It is clear from the explanation of FIG. 3 that in a simple manner, switching of the liquid coolant circuits is possible and hence a different coupling of the interior heat exchanger 19 and external air heat exchanger 27 with the gas cooler 7 and evaporator 9 depending on operating state, as was explained with reference to FIGS. 1 and 2.

The heating/cooling device 1 is preferably constructed very compactly in that the pumps 15 and 25, where applicable also the pump 67, together with changeover valves 47, 49, 51 and 53, where applicable also with mixer valve 65, can be combined into one assembly or function block, the coolant block KüMB. The gas cooler 7, compressor 3, evaporator 9 and the refrigerant circuit 5 (not shown in FIG. 3 but depicted in FIGS. 1 and 2) can also be formed as a separate refrigerant block KüMB. Above the coolant block KüMB is arranged the vehicle periphery with which the coolant block KüMB is in active and fluid connection. Finally it is possible to combine the coolant block KüMB and the refrigerant block KüMB into a single compact block or whole assembly.

In FIG. 3, the vehicle periphery and coolant block KüMB and refrigerant block KüMB are delimited from each other by dotted lines.

The heating/cooling device 1 described here serves for heating and cooling of vehicles, in particular motor vehicles, which are formed as electric and hybrid vehicles. As this device is constructed extremely compactly, also because of the heat transfer to a liquid coolant in the gas cooler 7 or evaporator 9, the device can also easily be used in small vehicles.

From the explanations for FIG. 3 it is also clear that, with adequate natural temperature gradients between the interior of the vehicle and the environment, heat transport is possible without the use of the compressor and refrigerant circuit. In this case the connections K of the changeover valves 47 and 49 are switched to passage to the unmarked connection, and the connections H of the changeover valves 47 and 53 to passage to the unmarked connection.

It is therefore evident that the heating/cooling device 1 described here is extremely flexible in use.

FIG. 4 shows a heating/cooling module 68 for the heating/cooling device 1. The same elements and those with equivalent function carry the same reference numerals, so to this extent reference is made to the preceding description. The heating/cooling module 68 is formed extremely compactly and comprises in particular a minimum number of connections and valves. It can be connected to a periphery (not shown) of an assembly which comprises a heating/cooling device 1, for example a vehicle periphery.

The heating/cooling module 68 has a first input 70, a second input 71, a first output 73 and second output 75 for a liquid coolant. Thus in total four connections are provided for connection to the periphery.

The heating/cooling module 68 comprises the gas cooler 7, compressor 3 and evaporator 9.

As already explained, these elements are part of a refrigerant circuit which is not shown in FIG. 4. With regard to its construction and function, reference is made to the preceding description.

The first input 70 is connected to the coolant input of the gas cooler 7, wherein the coolant flows through this in the direction of arrow 17. Irrespective of the switching state of the heating/cooling module 68, the first input 70 is always connected to the first output 73 so that a first partial liquid coolant circuit 77 is formed.

The second output 75 is connected to a coolant output of the evaporator 9 through which coolant flows in the direction of arrow 17′. Irrespective of the switching state of the heating/cooling module 68, the second output 75 is always connected to the first input 71 so that here a second partial liquid coolant circuit 79 is formed.

The heating/cooling module 68 also comprises a valve device 81 by means of which the compressor 3 can be allocated either to the first partial liquid coolant circuit 77 or to the second partial liquid coolant circuit 79, i.e. it can be integrated therein.

The valve device 81 in the embodiment example shown comprises two changeover valves 83, 85 which are preferably motor-controlled. For this, in this case motors 87, 89 are provided. As has been already explained, the changeover valves 83, 85 also comprise connections marked H, K or unmarked. In a heating mode of the heating/cooling module 68, connections H are connected to the unmarked connections of valves 83, 85. Connections K are blocked accordingly. In cooling mode however the connections K are each connected to the unmarked connections while connections H are blocked.

The valve device 81 preferably comprises a valve assembly 91. In the embodiment example shown in FIG. 4 this is formed as a motorized valve 93 which comprises two valve actuators 95, 97. A motor 99 is provided via which the valve actuators 95, 97 can be adjusted in opposite directions. This means that valve actuator 97 is blocked when valve actuator 95 is switched to passage. Conversely valve actuator 95 is blocked when valve actuator 97 is switched to passage.

First the heating mode of the heating/cooling module 68 is explained below:

Liquid coolant flows through the first input 70 to the gas cooler 7 in which it is heated. As the input K of changeover valve 83 is blocked, the coolant flows on to the valve actuator 97 which in heating mode is switched to passage. From there it flows on to the first output 73. It cannot flow back through the changeover valve 85 because its output K is blocked. The first partial liquid coolant circuit 77 in heating mode thus comprises the gas cooler 7, so that the coolant is heated here. The heating/cooling device 1 which comprises the heating/cooling module 68 preferably has suitable means for connecting the first partial liquid coolant circuit 77 in heating mode to the interior heat exchanger 19, in order to implement the first liquid coolant circuit 13 according to FIG. 1. The first partial liquid coolant circuit 77 is then also comprised by the first liquid coolant circuit 13.

It is also shown that in heating mode, by means of the valve device 81, in particular via the valve assembly 91, the coolant output of the gas cooler 7 is connected to the first output 73.

Coolant which enters the heating/cooling module 68 through the second input 79, in heating mode reaches the input H of the changeover valve 83 because the valve actuator 95 is blocked. The input H of the changeover valve 83 is connected to its unmarked output. The coolant passes via this to the compressor 3. From there it flows to the unmarked input of the changeover valve 85 where it emerges through the output marked H because the output marked K is blocked. Since the valve actuator 95 is blocked, the coolant flows through the evaporator 9 and from there to the second output 75.

It is thus shown that in heating mode, by means of the valve device 81, the compressor 3 is connected with its coolant input to the second input 71 and with its coolant output to the coolant input of the evaporator 9.

The second part coolant circuit 79 thus also comprises the compressor 3 and evaporator 9. The heating/cooling device 1 which comprises the heating/cooling module 68 preferably has means for connecting the second input 71 and the second output 75 to the external air heat exchanger 27. The second liquid coolant circuit 23 then comprises the second partial liquid coolant circuit 79.

Thus it is shown that in heating mode, finally the liquid coolant circuits 13, 23 according to FIG. 1 are implemented if the periphery is now included. The heating/cooling module provides the corresponding functionality very compactly with just four connections for coolant and a minimum number of valves.

The cooling mode of the heating/cooling module 68 is explained in more detail below.

The liquid coolant flows through the first input 70 to the coolant input of gas cooler 7. It flows through this in the direction of arrow 17 and reaches its coolant outlet. From here it reaches the input marked K of the changeover valve 63 which is connected to the unmarked output. The coolant flows through the valve 83 because valve actuator 97 is blocked in cooling mode. From the unmarked output of the valve 83, the coolant reaches the compressor 3 through which it flows and from there it passes to the unmarked input of the changeover valve 85. This is connected to the output marked K so that the coolant flows from there to the first output 73. The valve actuator 97 is blocked so that the coolant cannot flow back via this. Also the inputs and/or outputs of the changeover valves 83, 85 marked H are blocked.

The first partial liquid coolant circuit 77 in cooling mode thus comprises the gas cooler 7 and compressor 3. It is shown that then, by means of the valve device 81, the compressor 3 is connected with its coolant input to the coolant output of the gas cooler 7 and with its coolant output to the first output 73.

The heating/cooling device 1 which comprises the heating/cooling module 68 preferably has means which connect the first partial liquid coolant circuit 77 in cooling mode with the external air heat exchanger 27. In this case the first partial liquid coolant circuit 77 is then allocated to the second liquid coolant circuit 23 according to FIG. 2.

Thus the waste heat from compressor 3, together with the heat absorbed by the liquid coolant in the gas cooler 7, is emitted via the external air heat exchanger 27.

The coolant flowing through the second input 71 into the heating/cooling module 68 cannot flow through the changeover valve 83 because its input marked H is blocked. The valve actuator 95 in cooling mode is switched to passage, so that the coolant flows from the second input 71 via this to the coolant input of the compressor 9. It cannot flow via the changeover valve 85 because its input H is blocked. It flows through the evaporator 9 along arrow 17′ and via its coolant output reaches the second output 75.

The second partial liquid coolant circuit 79 in cooling mode thus comprises the compressor 9. It is also clear that by means of the valve device 81, here in concrete terms the valve assembly 91, in cooling mode the second input 71 is connected to the coolant input of the evaporator 9.

The heating/cooling device 1 which comprises the heating/cooling module 68 preferably has means which in cooling mode connect the second partial liquid coolant circuit 79 to the interior heat exchanger 19. Thus in cooling mode the second partial liquid coolant circuit 79 is allocated to the first liquid coolant circuit 13 according to FIG. 2.

In total it is found that using the heating/cooling module 68, in cooling mode the functionality of the heating/cooling device 1 shown in FIG. 2 is implemented.

FIG. 5 shows a second embodiment example of the heating/cooling module 68. The same elements and those with equivalent function carry the same reference numerals so that to this extent reference is made to the preceding description. The functionality and allocation of the coolant flows in heating and cooling mode of the embodiment example shown in FIG. 5 correspond fully to those of the embodiment example in FIG. 4. To this extent reference is made to the preceding depiction.

The valve assembly 91 is however formed differently here: it comprises two temperature-controlled valves 101, 103. These preferably comprise a bimetal control or bimetal actuator assembly. Dotted line L indicates that the temperature-controlled valve 101 detects the temperature of the coolant which flows through the second input 71 into the heating/cooling module 68. At low temperature it is closed, and it opens in a preferred embodiment example when the coolant at the measurement point, i.e. in the region of the second input 71, has a temperature above 15° C. Preferably the temperature-controlled valve 101 has a switch hysteresis of particularly preferably 3 to 5 K. After it has opened due to the temperature rise above 15° C., it preferably then closes when the temperature at the measurement point falls to around 10 to 12° C. or below.

A dotted line L′ indicates that the valve 103 detects the temperature of the coolant in the region of the coolant output of the compressor 3. It is open when the coolant is comparatively cold, and it closes in a preferred embodiment example at a coolant temperature of above 50° C. at the measurement point. Preferably the valve 103 has a switch hysteresis of particularly preferably around 3 to 5 K. After it has closed due to the temperature rise above 50° C., it preferably opens again when the temperature at the measurement point falls to around 45 to 47° C. or below.

With regard to valve 101, the following is shown:

In heating mode the coolant flowing from the evaporator 9 through the second output 75 on the periphery side reaches the external air heat exchanger 27. From there it passes to the second input 71 where it has a temperature at which valve 101 is closed. Consequently—as already explained—it flows to the input H of the changeover valve 83 and does not pass through valve 101.

In cooling mode the coolant on the periphery side flows through the interior heat exchanger 19 where it absorbs comparatively a great deal of heat. From there it passes to the second input 71 with a temperature at which valve 101 is opened. As the input marked H of the changeover valve 83 is blocked, the coolant flows through valve 101 and thus reaches the coolant input of the evaporator 9.

With regard to valve 103 the following is shown:

The coolant flowing in heating mode on the periphery side from the external air heat exchanger 27 to the second input 71 is comparatively cold and flows via the changeover valve to the compressor 3. As it arrives there comparatively cold, at its coolant output, i.e. after it has absorbed the waste heat from the compressor 3, it has a temperature at which valve 103 is open. The coolant coming from the gas cooler 7 can thus flow through the valve 103 and thus reach the first output 73.

In cooling mode, coolant is supplied to the compressor 3 via the changeover valve 83, having previously passed over the gas cooler 7. Here it has already absorbed heat and is therefore relatively warm. On flowing through the compressor it also absorbs its waste heat, so that at its coolant output it has a temperature at which valve 103 is closed. Therefore the coolant coming from the gas cooler 7 cannot flow through the valve 103 to the first output 73.

The valve assembly 91 with the temperature-controlled valves 101, 103 consequently implements the same functionality as the valve assembly 91 in FIG. 4 which has the motorized valve 93. In the embodiment example according to FIG. 5 however no external control logic is required to control the valves 101, 103. Instead these auto-regulate their opening and closing states on the basis of the temperature of the coolant predominating at the measurement points. Therefore this embodiment example of the heating/cooling module 68 is constructed more simply.

The following is also shown: The heating/cooling device 1 which comprises the heating/cooling module 68 preferably has at least one valve device in the periphery. By means of this, in cooling mode preferably the first input 70 can be connected to a coolant output of the external air heat exchanger 27, and the first output 73 can be connected to its coolant input. Thus the second coolant circuit 23 according to FIG. 2 can be implemented. At the same time preferably the second input 71 can be connected to a coolant output of the interior heat exchanger 19, and the second output 75 can be connected to its coolant input so that the first coolant circuit 13 according to FIG. 2 is implemented.

In heating mode, by means of the valve device preferably the first input 70 of the heating/cooling module 68 can be connected to a coolant output of the interior heat exchanger 19, and the first output 73 can be connected to its coolant input in order to implement the first coolant circuit 13 according to FIG. 1. Also the second input 71 can be connected to a coolant output of the external air heat exchanger 27 and the second output 75 can be connected to its coolant input in order to implement the second coolant circuit 23 according to FIG. 1.

Finally thus, by means of the at least one valve device, it is ensured that the functionality of the heating/cooling device 1 which was described in connection with FIGS. 1 to 3 is also implemented with the inclusion of the heating/cooling module 68.

The periphery is preferably that of a vehicle. This comprises preferably also pumps 15, 25 and where applicable mixer valve 65 and pump 67.

The heating/cooling device 1 is in particular advantageous because in heating mode not only the waste heat of the compressor but also heat absorbed via the external air heat exchanger, which is supplied to the evaporator 9 via the second coolant circuit 23, is made available via the refrigerant circuit to the gas cooler 7 and finally to the first coolant circuit 13. Thus a heat pump is achieved which comprises the external air heat exchanger 27 as heat source and the internal heat exchanger 19 as a heat sink.

The basic concept of the present invention is not exclusively applicable in automotive technology. It is also equally suitable for use for air conditioning, heating or temperature control quite generally of interiors, in particular also offices or living areas.

If the periphery however is that of a vehicle, preferably on the periphery side also the battery and/or accumulator and in particular an electric motor of an electric vehicle can be included in the circuits. Thus it is possible to maintain the battery and/or accumulator of an electric vehicle always at a suitable temperature, in particular if coolant from the two circuits 13, 23 can be mixed for this. The electric motor of the vehicle, depending on operating state, can be switched as a heat source or where applicable as a heat sink.

In total it is thus found that the heating/cooling device 1 can be used very flexibly. The heating/cooling module 68 is very compact, has only a low number of valves and can be integrated easily in a periphery, preferably a vehicle periphery, with only four connections.

### LIST OF REFERENCE NUMERALS

1 Heating/cooling device

3 Compressor

5 Refrigerant circuit

7 Gas cooler

9 Evaporator

11 Line

13 First liquid coolant circuit

15 Pump

17 Arrow

17′ Arrow

19 Interior heat exchanger

21 Fan

23 Second liquid coolant circuit

25 Pump

27 External air heat exchanger

29 Fan

31 Line

33 Line

35 Line

37 Expansion valve

39 Line

41 Accumulator

43 Internal heat exchanger

45 Arrow

47 Changeover valve

49 Changeover valve

51 Changeover valve

53 Changeover valve

55 Line

57 Non-return valve

59 Tank

61 Tank

63 Non-return valve

65 Mixer valve

67 Pump

68 Heating/cooling module

69 Accumulator

70 Input

71 Input

73 Output

75 Output

77 Partial liquid coolant circuit

79 Partial liquid coolant circuit

81 Valve device

83 Changeover valve

85 Changeover valve

87 Motor

89 Motor

91 Valve assembly

93 Motorized valve

95 Valve actuator

97 Valve actuator

99 Motor

101 Valve

103 Valve

a Node point

b Node point

c Node point

d Node point

e Node point

f Node point

g Node point

KüMB Coolant block

KüMB Refrigerant block

1. A heating/cooling device for a vehicle, in particular a motor vehicle, that includes a compressor, a refrigerant circuit, a gas cooler, an evaporator, and with an expansion valve arranged between the gas cooler and the evaporator in the refrigerant circuit, wherein
the gas cooler or the evaporator is coupled with a liquid coolant circuit which cooperates with an interior heat exchanger or an external air heat exchanger, or that
the gas cooler and the evaporator are each coupled with its own liquid coolant circuit, wherein
one of the liquid coolant circuits cooperates with the interior heat exchanger and the other liquid coolant circuit cooperates with the external air heat exchanger.

2. A heating/cooling device according to claim 1, wherein the refrigerant circuit comprises an internal heat exchanger which transmits heat from the refrigerant flowing from the gas cooler to the expansion valve, to the refrigerant flowing from the evaporator to the compressor.

3. A heating/cooling device according to claim 1, wherein the refrigerant circuit has an accumulator integrated therein.

4. A heating/cooling device according to claim 1, wherein
when the gas cooler and the evaporator each comprise an own liquid coolant circuit,
in a heating mode the liquid coolant circuit of the gas cooler cooperates with the interior heat exchanger, and the liquid coolant circuit of the evaporator cooperates with the external air heat exchanger, and that
in a cooling mode the liquid coolant circuit of the gas cooler cooperates with the external air heat exchanger, and the liquid coolant circuit of the evaporator cooperates with the interior heat exchanger.

5. A heating/cooling device according to claim 4, wherein
the liquid coolant circuit of the gas cooler cooperates with at least two changeover valves which supply the liquid coolant, depending on operating mode, to the interior heat exchanger or the external air heat exchanger, and that
the liquid coolant circuit of the evaporator cooperates with at least two changeover valves which supply the liquid coolant, depending on operating mode, to the external air heat exchanger or the interior heat exchanger.

6. A heating/cooling device according to claim 4, wherein the compressor is included in the liquid coolant circuit which cooperates with the external air heat exchanger so that its operating heat can be dissipated.

7. A heating/cooling device according to claim 4, wherein between the liquid coolant circuit of the gas cooler and the liquid coolant circuit of the evaporator, a valve is provided via which the heat from the liquid coolant circuit of the gas cooler in heating mode can be introduced into the evaporator.

8. A heating/cooling device according to claim 7, wherein the valve is formed as a non-return valve, an electrically controlled valve or as a thermostatically controlled valve.

9. A heating/cooling device according to claim 4, wherein between the liquid coolant circuit of the gas cooler and the liquid coolant circuit of the evaporator, a mixer valve is provided to which warm liquid coolant from one of the two liquid coolant circuits and/or cold liquid coolant from the other liquid coolant circuit is supplied so that tempered liquid coolant is available from the mixer valve for a consumer, preferably an accumulator.

10. A heating/cooling device according to claim 4, wherein the at least two changeover valves and the pumps can be combined as an assembly into a coolant block.

11. A heating/cooling device according to claim 4, wherein the compressor, the gas cooler and the evaporator can be combined as an assembly into a refrigerant block.

12. A heating/cooling device according to claim 11, wherein the coolant block and the refrigerant block can be combined into a single whole assembly.

13. A heating/cooling module for a heating/cooling device according to claim 1, with comprising:
a first input which is in fluid connection with a coolant input of a gas cooler;
a first output, wherein
the first input is in fluid connection with the first output so that a first partial liquid coolant circuit is formed;
a second input;
a second output which is in fluid connection with the coolant output of an evaporator;
wherein the second input is in fluid connection with the second output so that a second partial liquid coolant circuit is formed; and
a compressor, comprising a valve device by means of which the compressor can be allocated optionally to the first or the second partial liquid coolant circuit.

14. A heating/cooling module according to claim 13, wherein by of the valve device, the compressor can be connected
with its coolant input to the second input and with its coolant output to the coolant input of the evaporator, or
with its coolant input to the coolant output of the gas cooler and with its coolant output to the first output.

15. A heating/cooling module according to claim 1, wherein by moans of the valve device,
the coolant output of the gas cooler can be connected to the first output, or
the second input can be connected to the coolant input of the evaporator.

16. A heating/cooling module according to claim 1, wherein the valve device comprises two preferably motor-controlled changeover valves, by which the coolant input of the compressor can be connected to the second input or to the coolant output of the gas cooler, and the coolant output of the compressor can be connected to the coolant input of the evaporator or to the first output.

17. A heating/cooling module according to claim 1, wherein the valve device comprises a valve assembly, by which the second input can be connected to the coolant input of the evaporator or the coolant output of the gas cooler can be connected to the first output.

18. A heating/cooling module according to claim 17, wherein the valve assembly is formed as a motorized valve with two valve actuators which can be adjusted in opposite directions.

19. A heating/cooling module according to claim 17, wherein the valve assembly comprises two temperature-controlled valves.

20. A heating/cooling device according to claim 1, comprising a heating/cooling module, comprising:
a first input which is in fluid connection with a coolant input of a gas cooler;
a first output; wherein
the first input is in fluid connection with the first output so that a first partial liquid coolant circuit is formed,
a second input;
a second output, which is in fluid connection with the coolant output of an evaporator, wherein the second input is in fluid connection with the second output so that a second partial liquid coolant circuit is formed; and
a compressor comprising a valve device by means of which the compressor can be allocated optionally to the first or the second partial liquid coolant circuit.

21. A heating/cooling device according to claim 20, comprising at least one valve device, by which
the first input of the heating/cooling module can be connected to a coolant output of the external air heat exchanger or of the interior heat exchanger,
the second input can be connected to a coolant output of the interior heat exchanger or of the external air heat exchanger,
the first output can be connected to a coolant input of the external air heat exchanger or of the interior heat exchanger, and
the second output can be connected to a coolant input of the interior heat exchanger or of the external air heat exchanger.
